(19) United States
(12) Patent Application Publication
(10) Pub. No.: US 2006/0072327 A1
(43) Pub. Date: Apr. 6, 2006

(54) Gooseneck lighting apparatus with decorative jelly sleeve

(75) Inventor: Lee Schaak, Dix Hills, NY (US)

Correspondence Address: DARBY & DARBY P.C., P. O. BOX 5257, NEW YORK, NY, 10150-5257, US

(73) Assignee: Adesso Inc., New York, NY (US)

(21) Appl. No.: 10/955,955

(22) Filed: Sep. 30, 2004

(51) Int. Cl. F21V 19/00

(52) U.S. Cl. 362/382

(57) ABSTRACT

A lighting apparatus includes a gooseneck support arm covered with a resilient, elastomer colored decorative jelly sleeve. The decorative jelly sleeve is made from a resilient elastomeric material and circumferentially surrounds the gooseneck. The jelly sleeve imparts a compressive force on the gooseneck creating, in combination with a coefficient of static friction, a frictional force that is greater than an axially deforming force exerted on the sleeve by a radial bending motion of the gooseneck. The jelly sleeve is capable of returning to an original shape and size after removal of the axially deforming force. The lighting apparatus can include multiple gooseneck arms each covered by a jelly sleeve, and be configured as a desk lamp, a floor lamp, a wall lamp, or a clampable lamp.

### FIELD OF INVENTION

The present invention relates to a lighting apparatus, and more particularly, to a lighting apparatus which have light sources positioned at the end of a gooseneck support that is itself surrounded by a decorative jelly sleeve.

### BACKGROUND OF THE INVENTION

Conventional lighting apparatuses are useful as sources of electrical light and are also popular for decorative purposes. There are many different categories of lighting apparatuses, including desk lamps, floor lamps, overhead lamps, and recessed lamps. Within each of these categories there are numerous varieties of lighting apparatuses.

Adding to this enormous diversity some desk lamps and floor lamps, in particular, have incorporated a gooseneck support in the design of the lamp. The gooseneck provides a functionality that allows the user to reposition a light source in a number of different positions that is limited only by the length, flexibility, and resiliency of the gooseneck. The gooseneck's flexibility and resiliency is an inherent characteristic of the gooseneck's construction and material; usually a metal, e.g., aluminum, steel, or copper. The gooseneck itself is generally available in colors limited to the metallic shades of its composite metal. The corrugated construction of the gooseneck makes it difficult for applied pigments or fanciful designs to adhere to its surface. Constructing a gooseneck from a corrugated plastic or vinyl covering merely allows for the introduction of a variety of colors on the gooseneck support. The corrugated outer texture remains as an element of the lamp, which still limits the application of fanciful designs to the gooseneck support.

In particular there is a need for a lighting apparatus that includes a gooseneck support which provides an outer covering capable of providing a variety of colors and fanciful designs. The present invention satisfies at least these needs.

### SUMMARY OF THE INVENTION

In accordance with one aspect of the invention, a lighting apparatus comprises a gooseneck articulable arm attached at a first portion to a support. A terminal housing is attached relative to a second portion of the gooseneck. Connected to the terminal housing is a bulb socket with wiring, and optionally a switch. A lamp shade is mounted to the terminal housing. A decorative jelly sleeve made from a resilient elastomeric material circumferentially surrounds the gooseneck. The jelly sleeve is snugly fitted about the gooseneck and imparts a compressive force on the gooseneck creating, in combination with a coefficient of static friction, a frictional force that is greater than an axially deforming force exerted on the sleeve by a radial bending motion of the gooseneck. After removal of the axially deforming force, the sleeve returns to an original size and shape.

In accordance with a further aspect of the invention, the lighting apparatus can include multiple goosenecks and lamp assemblies formed from the terminal housing, bulb socket and lamp shade.

In accordance with another aspect of the invention, the support is connected to a lamp post, a spring-loaded clamp, a mounting bracket, or a lamp base.

These and other aspects, features, steps and advantages can be further appreciated from the accompanying drawing Figures and description of certain illustrative embodiments.

### BRIEF DESCRIPTION OF THE DRAWINGS

FIG. 1 is a perspective view of a lighting apparatus in accordance with an embodiment of the invention;

FIG. 2 is an enlarged exploded perspective view of a portion of the embodiment of FIG. 1;

FIG. 3a is a perspective view of a lighting apparatus in accordance with another embodiment the invention;

FIG. 3b is a perspective view of a lighting apparatus in accordance with another embodiment the invention;

FIG. 3c is a perspective view of a lighting apparatus in accordance with another embodiment the invention; and

FIG. 3d is a perspective view of a lighting apparatus in accordance with another embodiment the invention.

### DETAILED DESCRIPTION OF ILLUSTRATED EMBODIMENTS

By way of overview and introduction, described is a lighting apparatus that includes a gooseneck support for a lamp assembly, where the gooseneck support is covered with a resilient, elastomer colored decorative jelly sleeve. The lamp assembly itself can, optionally, include a lamp shade which is color coordinated with the jelly sleeve. The lighting apparatus can have multiple gooseneck supports, each supporting a respective lamp assembly. Additionally, the lighting apparatus can be configured as a desk lamp, a floor lamp, a wall lamp, or a clampable lamp.

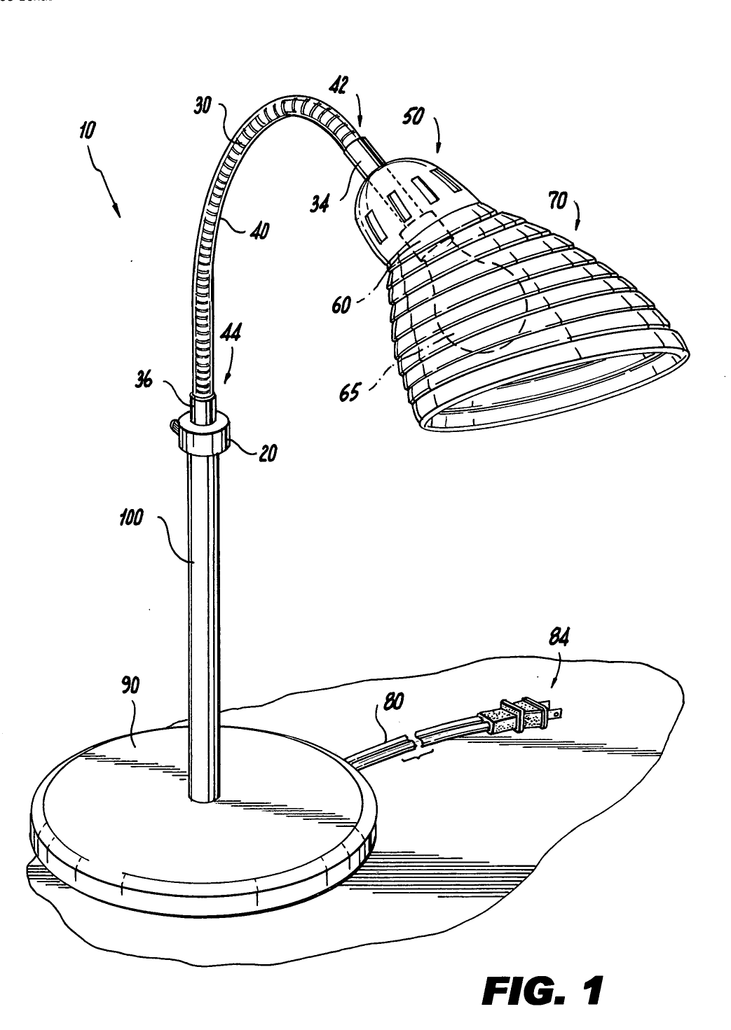

FIG. 1 illustrates a perspective view of a lighting apparatus 10 in accordance with an embodiment of the invention. The lighting apparatus 10 includes a support 20 to which is connected a flexible gooseneck 30 that is covered by a jelly sleeve 40. The support 20 further includes a stem, that extends from the support and which is sized to receive a portion of the gooseneck 30. Instead of a stem, the support 20 can be provided with an aperture (e.g., in an upper surface thereof), with the aperture sized to receive the gooseneck 30. Other known bonding methods (e.g., rivets, welding, soldering, adhesives, etc.) can be used to connect the gooseneck to the support.

At an end of the gooseneck 30 remote from the support 20 is a terminal housing 50, to which is mounted a bulb socket 60 and a lamp shade 70. The lamp shade 70 can have may configurations and adds an eye-pleasing finishing touch to the lighting assembly. The lamp shade 70 can be a light globe, a light shade, or any other suitable surround for a light source 65, as is known in the art. Power cord 80 is composed of lamp cord, includes an electrical power plug 84 at one end, and is conductively coupled at its other end to the bulb socket 60 either directly, or through a switch 86 (not shown). The switch 86 can be located along the lamp cord, integral to the bulb socket 60, mounted to the terminal housing, or mounted to another portion of the lighting apparatus 10. The mechanism for switch 86 can be activated by a rotary, push, or pull member. The light source 65 (e.g., incandescent bulb, halogen lamp, fluorescent bulb, or one or more LEDs) can be mounted in the bulb socket 60 and positioned in a plurality of positions relative to the support 20 by arrangement of the flexible gooseneck. FIG. 1 illustrates an embodiment of lighting apparatus 10 which includes a lamp post 100 and a base 90 that, in cooperation, elevates the support 20, flexible gooseneck 30 and the lamp assembly. The base 90 has a mass which is sufficient to overcome any turning moments created when the light source 65 is cantilevered out beyond an edge E of the base 90, and thus prevents the lighting assembly 10 from tipping.

FIG. 1 illustrates a single gooseneck; however, the invention is not so limited. Rather, multiple goosenecks 30a can be provided within the scope of the present invention. The flexible gooseneck 30 permits users to position their light source 65 anywhere over a wide range of positions relative to the base 90. Thus, users may achieve their lighting needs and/or express their individual artistic ability by presenting their light source in a position which is aesthetically pleasing or provides the optimal amount of light for their purposes. Embodiments comprised of multiple flexible goosenecks 30, 30a offer the user even more self-artistic expression by enabling the user to create different lighting effects. The embodiments of the invention are not limited to one or two goosenecks, but can contain any number as can be accommodated by the support 20. Users can readily alter the ambient lighting by casting light in various directions according to their needs, or to create a lighting effect most pleasing to themselves, as well as others.

The flexible gooseneck 30 comprises a jointed, articulatable tube that extends along an axial length between first and second ends. An exemplary gooseneck, is formed from two coaxially positioned, loosely-wound springs. Each spring having a pitch defining a spacing between consecutive windings. Preferably, an outer spring has a rectangular cross section and its pitch approximates or equals the cross section of an inner spring. The inner spring has a circular cross section and its pitch approximates or equals the cross section of the outer spring. The inner diameter of the outer spring and the outer diameter of the inner spring are sized such that the inner spring fits snugly within, and pressably against, the outer spring. The inner spring is typically, and preferably, stiffer than the outer spring. Other cross sections or constructions of goosenecks are possible.

The articulatable tube of the flexible gooseneck 30 has a resiliency which is sufficient to support a load imposed by the housing 50, the light bulb socket 60 and a lamp shade 70. In particular, the flexible gooseneck 30 demonstrates its resiliency by having the characteristic capability of recovering its shape after deformation. With this resiliency, a user can freely position a light source 65 relative to the base 90. More particularly, a load defined by the housing 50, the light bulb socket 60, and the lamp shade 70 is insufficient to cause the flexible gooseneck 30 to sag or otherwise change its position from that selected by the user.

The gooseneck is circumferentially surrounded by a jelly sleeve 40. The “jelly” sleeve is made of a polymeric or elastomeric compound (e.g., a material that returns to its original shape after a deforming force is removed such as plastic or rubber) that exhibits resilient and elastic properties. The jelly sleeve is formed as a hollow tube, with inner and outer walls extending between first and second ends 42, 44 that are separated from one another in an axial direction. The inside diameter of the jelly sleeve 40 is sized to snugly fit around at least a portion of the outer spring of the flexible gooseneck 30; preferably, at all portions of the gooseneck. Where the jelly sleeve snugly fits about the gooseneck, it imparts a compressive force F_{N} on the gooseneck creating, in combination with a coefficient of static friction, a frictional force that is greater than axially deforming forces F₁, F₂ exerted on the sleeve by a radial bending motion M_{R} of the gooseneck. The compressive force F_{N} is itself a force that is normal to the jelly sleeve axis. The axially deforming forces are created by the bending motion and include a tensile force F₁ formed on an outer arc of the gooseneck radial bend, and a compressive force F₂ formed on an inner arc. The resilient and elastic properties of the jelly sleeve 40 accommodates the tensile and compressive forces F₁, F₂ such that the jelly sleeve is not deformed beyond the material's Hookean elasticity point, as is known in the art. Therefore the jelly sleeve returns to its nominal at rest length and at rest wall thickness with no deformation in the material (i.e., the jelly sleeve remains snugly fitted about the gooseneck regardless of the bending radius). The resiliency and elasticity of the jelly sleeve material allows the sleeve to return to its original dimensions and shape after the axially deforming forces are removed.

The lighting apparatus 10, in an alternative embodiment comprises a first terminal coupling link 34 disposed between the gooseneck 30 and the support 20, and a second terminal coupling link 36 disposed between the gooseneck portion remote from the support and the terminal housing. The coupling links 34, 36 aid in securing the gooseneck to the support and act as a transition from the corrugated outer shell of the gooseneck to the support. The jelly sleeve circumferentially surrounds, and snugly fits about the terminal links in a manner as previously described. In a preferred embodiment, the jelly sleeve can be shrink-wrapped by heating so as to more firmly fit about the coupling links. The compressive force F_{N} exerted by of the resilient and elastomeric jelly sleeve overcomes any axially deforming forces exerted on the sleeve at the coupling links 34, 36, so that the sleeve remains snugly fitted about the coupling links across the full range of radial bending experienced by the gooseneck.

In one embodiment, the jelly sleeve 40 may contain a lumen between the outer and inner walls. This lumen can be filled with one, or a combination of the following, gas, liquid, solid, gel, or glitter material. The filled lumen is of a construction that does not impede the ability of the sleeve material to flex with the movement of the gooseneck. The glitter or small pieces of foil cut into small shapes or designs could be located within the lumen to create a fanciful design.

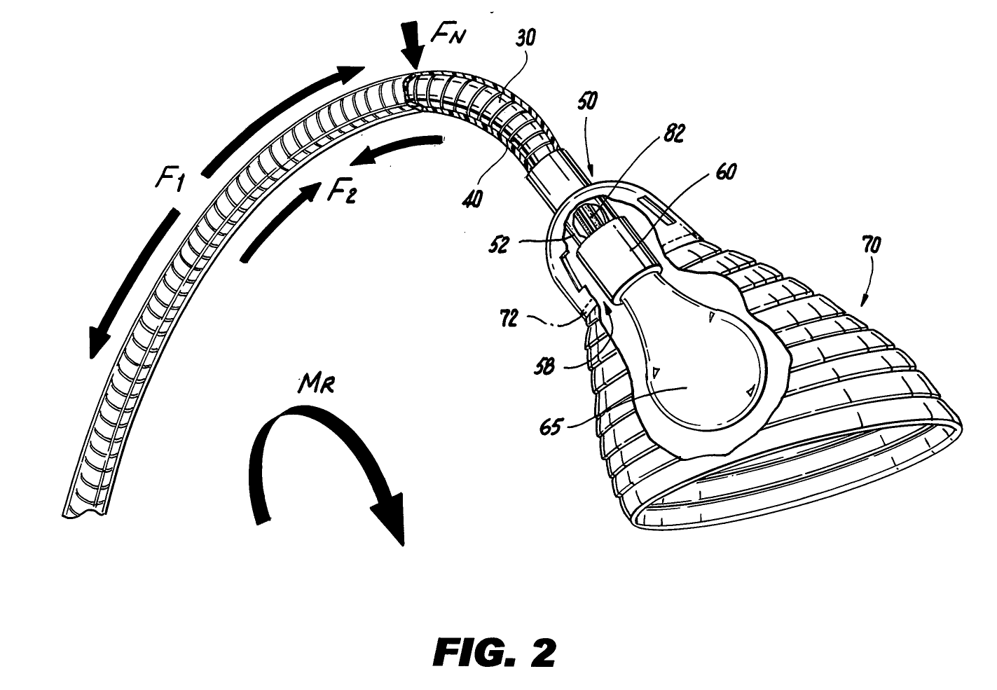

FIG. 2 depicts an enlarged exploded perspective view of a portion of the lighting apparatus illustrated in FIG. 1. A stem 52 is extended from the gooseneck to mount the bulb socket 60. Alternatively, the bulb socket can be mounted to a shelf bracket 56 (not shown) attached to an inside wall of the terminal housing 50. Other configurations that mount the bulb socket to the housing can be implemented as is known to a person of ordinary skill in the art. A pair of insulated conductive cord members 82 is conductively connected to the bulb socket 60.

The lamp shade 70 is detachably mounted to the terminal housing 50 by extending an end 72 into an accommodating corresponding space 58 of the housing. The lamp shade is attached to the housing by detachably securing end 72 with fastening lugs, screw, or posts screwed into threaded holes in the accommodating section 58. Other manners of mounting the lamp shade 70 to the housing 50, as is known by persons of skill in the art, are within the scope of the invention (e.g., rivets, press points, adhesive, welding, etc.).

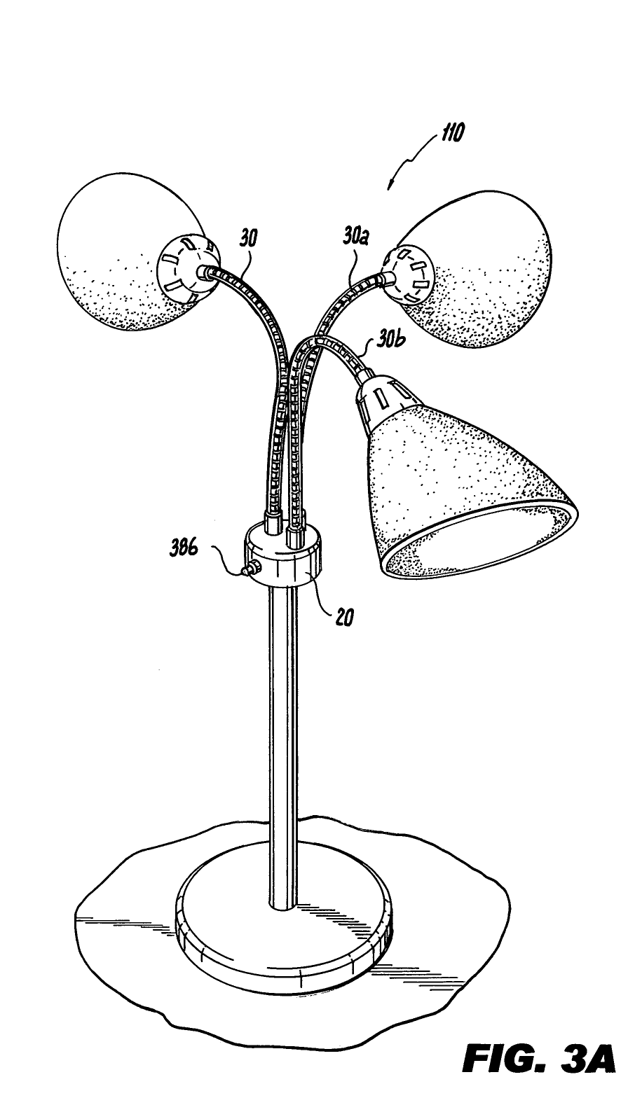

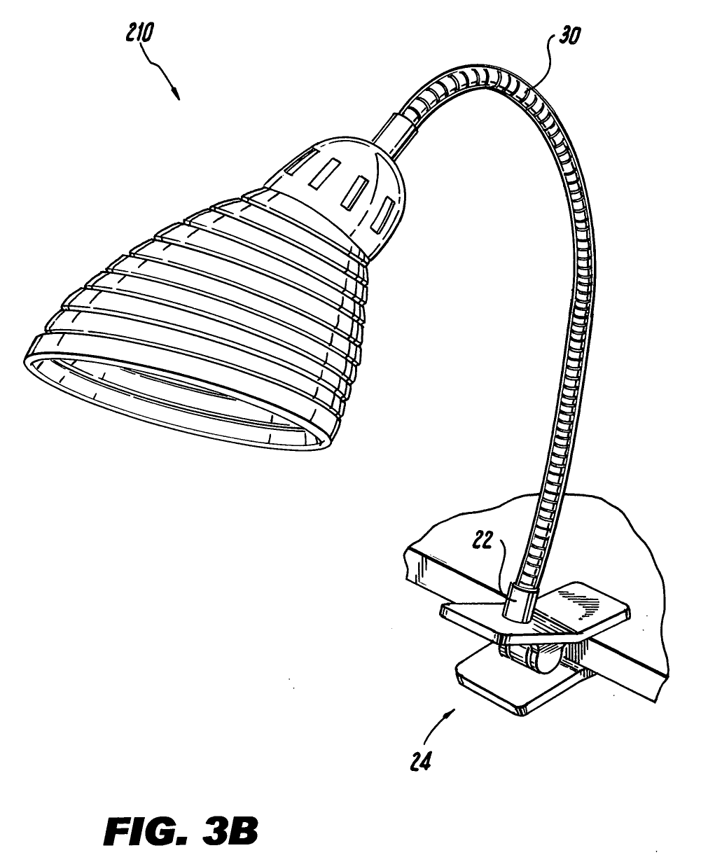

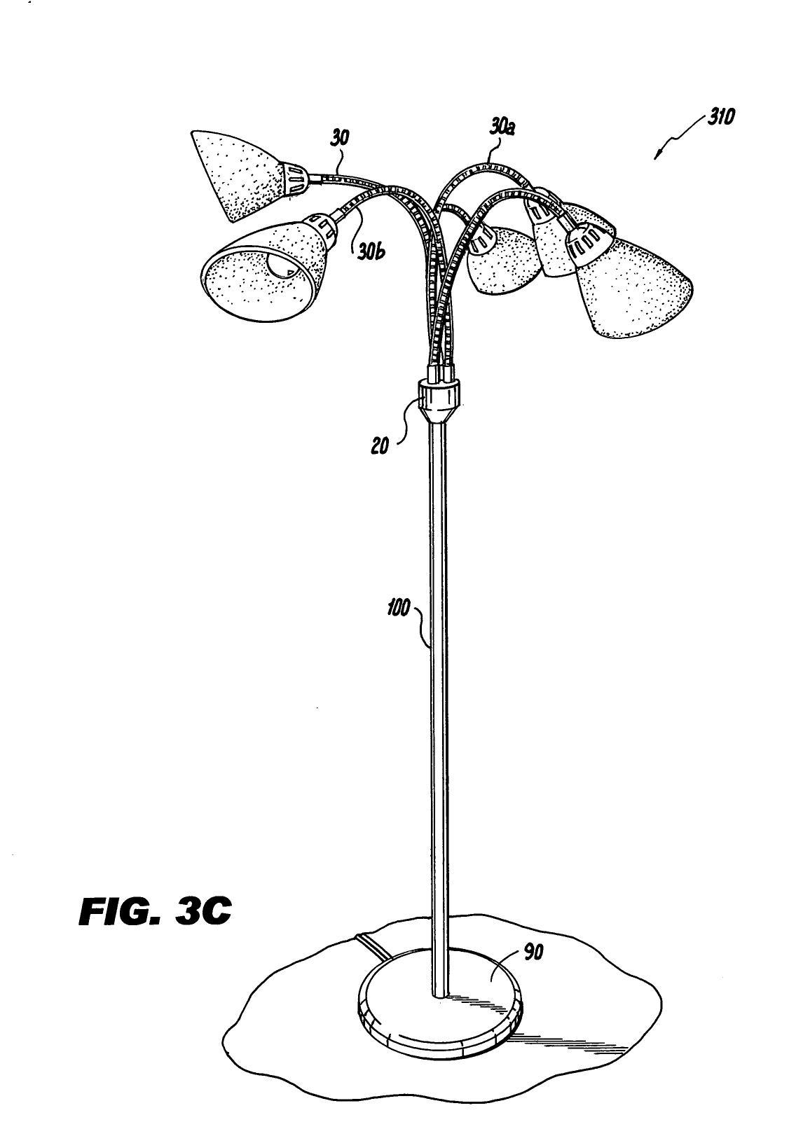

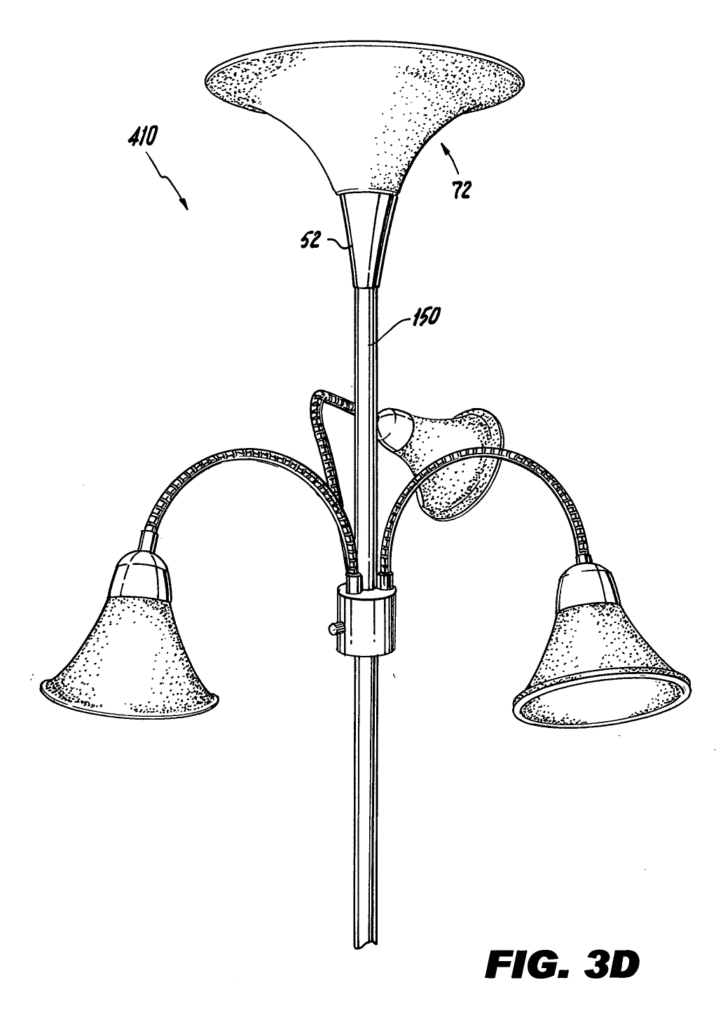

FIG. 3a depicts another embodiment of the lighting apparatus. Lighting apparatus 110 is a desk lamp with one or more gooseneck and lamp assemblies. Support 20 accommodates multiple gooseneck supports 30, 30a, 30b all of which are mounted to the support in a like manner as previously described. A switch 386 is illustrated protruding from the support 20.

FIG. 3b illustrates another embodiment of the lighting apparatus. Lighting apparatus 210 is mountable to a suitable surface by clamp 22. The gooseneck support 30 is attached to a support 22 that is in turn connected securely to clamp 24. Clamp 24 can be either a spring-loaded clip, a clamp, a mounting bracket, or any other configuration as known in the art. Clamp 22 allows a user to fix the lamp to a surface on which such a mechanism can be used, such as the edge of a table, a shelf, a headboard, etc.

FIG. 3c illustrates another embodiment of the lighting apparatus. Lighting apparatus 310 has multiple gooseneck supports 30, 30a, 30b, etc., each with a lamp assembly attached thereto, connected to support 20. Although the multiple gooseneck supports are provided from a common support 20, each gooseneck can have a different axial length than another. The variations in axial lengths can add to the aesthetic appeal and practicality of the lighting apparatus.

FIG. 3d illustrates another embodiment of the lighting apparatus. Lighting apparatus 410, in addition to having multiple gooseneck supports, has a column 150 attached to, and extending from support 20. At an end remote from support 20, a terminal housing 52 is attached to column 150. A bulb socket 60 and a lamp shade 72 are attached to terminal housing 52.

Thus, while there have been shown, described, and pointed out fundamental novel features of the invention as applied to several embodiments, it will be understood that various omissions, substitutions, and changes in the form and details of the devices illustrated, and in their operation, may be made by those skilled in the art without departing from the spirit and scope of the invention. Substitutions of elements from one described embodiment to another are also fully intended and contemplated. It is also to be understood that the drawings are not necessarily drawn to scale, but that they are merely conceptual in nature. The invention is defined solely with regard to the claims appended hereto, and equivalents of the recitations therein.

I claim:

1. A lighting apparatus comprising:
a support having at least a mount surface and an attachment surface;
a gooseneck arm comprising a jointed, articulatable tube having a first portion coupled to the support mount surface and a second portion remote from the first portion;
a terminal housing fixedly disposed relative to the gooseneck second portion;
a bulb socket including a seat portion attached to the terminal housing, and a shell portion shaped to receive a base of a light bulb;
a lamp cord including a pair of insulated conductive cord members, each having a first lead conductively coupled to the bulb socket, and a second lead that terminates in an electrical plug;
a sleeve including an outer wall and an inner wall that defines a hollow space extending between first and second sleeve ends, the sleeve snugly fitted circumferentially about at least a portion of the gooseneck; and
the sleeve having a resilient elastic property, such that the sleeve imparts a compressive force on the gooseneck creating, in combination with a coefficient of static friction, a frictional force that is greater than an axially deforming force exerted on the sleeve by a radial bending motion of the gooseneck;
wherein, after the removal of the axially deforming force, the sleeve returns to an original size and shape.

2. The lighting apparatus of claim 1, wherein the support attachment surface is connected to one of a spring-loaded clip, a clamp, a mounting bracket, and a lamp base.

3. The lighting apparatus of claim 1, wherein the support attachment surface is connected to a proximal end of a lamppost.

4. The lighting apparatus of claim 3, wherein a distal end of the lamppost is connected to one of a spring-loaded clip, a clamp, a mounting bracket, and a lamp base.

5. The lighting apparatus of claim 1, further comprising:
a first terminal coupling link disposed between the gooseneck first portion and the support mount surface;
a second terminal coupling link disposed between the gooseneck second portion and the terminal housing; and
the sleeve snugly fitted circumferentially about at least a portion of the first terminal coupling link and at least a portion of the second terminal coupling link, so as to impart a compressive force onto each coupling link creating, in combination with a coefficient of static friction, a frictional force that is greater than the axially deforming force.

6. The lighting apparatus of claim 1, further comprising a lamp shade mounted to the terminal housing;
wherein the bulb socket, the terminal housing, and the lamp shade define a load, and the jointed, articulatable tube of the gooseneck has a resiliency sufficient to support the load in a plurality of articulated positions.

7. The lighting apparatus of claim 1, wherein the sleeve further comprises a lumen between the outer wall and inner wall, and disposed within the lumen is at least one of a gas, a liquid, a solid, a gel, and a glitter material.

8. The lighting apparatus of claim 1, wherein at least the gooseneck, terminal housing, bulb socket, and sleeve form a lamp subassembly, the lighting apparatus further comprising:
an at least second lamp subassembly, wherein said at least second lamp subassembly gooseneck first portion is coupled to the support mount surface; and
an at least second lamp cord including a pair of insulated conductive cord members, each cord member having a first lead conductively coupled to said at least second lamp subassembly bulb socket, and a second lead conductively coupled to the electrical plug.

9. The lighting apparatus of claim 8, further comprising:
a column connected to the support mount surface;
a terminal housing connected to the column remote from the support mount surface;
a bulb socket mounted to the terminal housing; and
a lamp shade attached to the terminal housing.

10. The lighting apparatus of claim 8, wherein each said at least second lamp subassembly sleeve further comprises a lumen between the outer wall and inner wall, and disposed within the lumen is at least one of a gas, a liquid, a solid, a gel, and a glitter material.

11. The lighting apparatus of claim 8, wherein each said at least second lamp subassembly further comprises:
a first terminal coupling link disposed between the at least second lamp gooseneck first portion and the support mount surface;
a second terminal coupling link disposed between the at least second lamp gooseneck second portion and the corresponding terminal housing; and
the corresponding sleeve snugly fitted circumferentially about at least a portion of the first terminal coupling link and at least a portion of the second terminal coupling link, so as to impart a compressive force onto each coupling link creating, in combination with a coefficient of static friction, a frictional force that is greater than the axial deforming force.

12. The lighting apparatus of claim 8, wherein each said at least second lamp subassembly further comprises a lamp shade mounted to the terminal housing;
wherein each said at least second lamp subassembly and corresponding lamp shade defines a load, and the jointed, articulatable tube of the at least second lamp subassembly gooseneck has a resiliency sufficient to support the load in a plurality of articulated positions.

13. The lighting apparatus of claim 1, further comprising:
a switch that conductively couples the first lead to the bulb socket;
wherein the switch is operable by one of a push, a pull, a toggle, and a rotary action.

14. A lighting apparatus comprising:
a base having at least a lower surface and an upper surface;
a lamppost having a proximal end coupled to the base first surface, and a distal end remote from the proximal end;
a support having at least an attachment surface and a mount surface, the support attachment surface is connected to the lamp post distal end;
a gooseneck arm comprising a jointed, articulatable tube having a first portion coupled to the support mount surface and a second portion remote from the first portion;
a housing coupled to the gooseneck second portion;
a bulb socket having a shell portion shaped to receive a light bulb base and a seat attached to the housing;
a power cord, comprising a pair of insulated conductive cord members each having a first lead conductively connected to the socket and a second lead remote from the first lead conductively coupled to an electrical plug;
a resilient and elastic sleeve snugly fitted circumferentially about at least a portion of the gooseneck; and
the sleeve comprising an outer wall and an inner wall that defines a hollow space extending between first and second sleeve ends, wherein the sleeve imparts a compressive force on the gooseneck creating, in combination with a coefficient of static friction, a frictional force that is greater than an axially deforming force exerted on the sleeve by a radial bending motion of the gooseneck, and the sleeve returning to an original size and shape after the deforming forces are removed.

15. The lighting apparatus of claim 14, further comprising:
a first terminal coupling link disposed between the gooseneck first portion and the support mount surface;
a second terminal coupling link disposed between the gooseneck second portion and the housing; and
the sleeve snugly fitted circumferentially about at least a portion of the first terminal coupling link and at least a portion of the second terminal coupling link, so as to impart a compressive force onto each coupling link creating, in combination with a coefficient of static friction, a frictional force that is greater than the axially deforming force.

16. The lighting apparatus of claim 14, wherein the sleeve further comprises a lumen between the outer wall and inner wall, and disposed within the lumen is at least one of a gas, a liquid, a solid, a gel, and a glitter material.

17. The lighting apparatus of claim 14, further comprising:
a switch that conductively couples the first lead to the bulb socket;
wherein the switch is operable by one of a push, a pull, a toggle, and a rotary action.

18. A lighting apparatus comprising:
a base having at least a lower surface and an upper surface;
a lamppost having a proximal end coupled to the base upper surface, and a distal end remote from the first portion;
a support having at least a mount surface and an attachment surface, wherein the support attachment surface is connected to the lamp post distal end;
a gooseneck arm comprising a jointed, articulatable tube having a first portion coupled to the support mount surface and a second portion remote from the first portion;
a housing coupled to the gooseneck second portion;
a bulb socket having a shell portion shaped to receive a light bulb base and a seat attached to the housing;
a column having a first end connected to the support mount surface and a second end remote from the first end;
a second housing connected to the column second end;
a second bulb socket having a shell portion shaped to receive a light bulb base and a seat attached to the second housing;
a power cord, comprising a pair of insulated conductive cord members each having a first lead conductively connected to each of the sockets and a second lead remote from the first lead conductively coupled to an electrical plug;
a resilient and elastic sleeve snugly fitted circumferentially about at least a portion of the gooseneck; and
the sleeve comprising an outer wall and an inner wall that defines a hollow space extending between first and second sleeve ends, wherein the sleeve imparts a compressive force on the gooseneck creating, in combination with a coefficient of static friction, a frictional force that is greater than an axially deforming force imparted on the sleeve by a radial bending motion of the gooseneck, and the sleeve returning to an original size and shape after the deforming force is removed.

19. The lighting apparatus of claim 18, further comprising:
a first terminal coupling link disposed between the gooseneck first portion and the support mount surface;
a second terminal coupling link disposed between the gooseneck second portion and the housing; and
the sleeve snugly fitted circumferentially about at least a portion of the first terminal coupling link and at least a portion of the second terminal coupling link, so as to impart a compressive force onto each coupling link creating, in combination with a coefficient of static friction, a frictional force that is greater than the axially deforming force.

20. The lighting apparatus of claim 18, wherein the sleeve further comprises a lumen between the outer wall and inner wall, and disposed within the lumen is at least one of a gas, a liquid, a solid, a gel, and a glitter material.

21. The lighting apparatus of claim 18, further comprising:
a switch that conductively couples the first lead to the bulb socket;
wherein the switch is operable by one of a push, a pull, a toggle, and a rotary action.

22. A method of assembling a lighting apparatus, comprising the steps of:
providing a support having a mount surface, a gooseneck having first and second portions, and a resilient elastic sleeve that has outer and inner surfaces defining a hollow space extending between first and second sleeve ends;
circumferentially surrounding at least a portion of the gooseneck arm with the sleeve;
coupling the gooseneck first portion to the mount surface;
fixedly disposing a terminal housing relative to the gooseneck second portion;
heat-shrinking the sleeve material about the gooseneck; and
continuing the heat-shrinking step until the sleeve is snug about the gooseneck.

23. The method of claim 22, further comprising the steps of:
disposing first and second terminal coupling links to respective portions of the gooseneck;
circumferentially surrounding at least a portion of the first and at least a portion of the second terminal coupling links with the sleeve;
heat-shrinking the sleeve material about the terminal coupling links; and
continuing the heat-shrinking step until the sleeve is snug about the terminal coupling links.
